(19) United States
(12) Patent Application Publication
(10) Pub. No.: US 2009/0294524 A1
(43) Pub. Date: Dec. 3, 2009

(54) High Security Transaction Card System and Method

(76) Inventors: Lee R. Rice, Littleton, CO (US); David Lafore, Littleton, CO (US)

Correspondence Address: TIMOTHY J. MARTIN, P.C., 9250 WEST 5TH AVE, LAKEWOOD, CO, 80226, US

(21) Appl. No.: 11/883,452

(22) PCT Filed: Feb. 3, 2006
(86) PCT No.: PCT/US06/03958

§ 371 Date: Jul. 30, 2007

Related U.S. Application Data
(60) Provisional application No. 60/593,667, filed on Feb. 3, 2005.

(51) Int. Cl. G06K 5/00

(52) U.S. Cl. 235/380

(57) ABSTRACT

A secure transaction card system and method utilizes a transaction card and an authentication device. The transaction card includes a first electrical contact, a power supply device, a card memory that stores a card identifier and a magnetic strip provided with a thin film magnetic write head in electrical communication with the power supply device. The authentication device includes a housing with an access slot for the card, a power source, a second electrical contact structure, an authentication processor in electrical communication with the second electrical contact structure and the power source, and a programmable memory storing account information corresponding to the transaction card. When the transaction card is mated with the authentication device, the processor causes account information to be written onto the magnetic strip so that the card can be used. After an interval of time, electrical charge is drained so that the card is inoperable.

### FIELD OF THE INVENTION

The present invention broadly concerns transactions wherein a user employs a transaction card. Such transactions may typically be, but are not limited to, electronic funds transactions utilizing credit or debit cards. More particularly, the exemplary embodiment described herein concerns a transaction card system and method that reduces the risk of fraud. Specifically, this embodiment is a two-component system and a method implemented by that system wherein authentication of a transaction card is required before use.

### BACKGROUND OF THE INVENTION

The conduct of commercial transactions has always required some method for the exchange of goods and services among the population. In early times, commercial transactions were based upon a “barter economy”. Here, an individual would trade his/her goods or services for the goods or services of another. This, of course, is inefficient where a first individual wants the goods or services of a second individual, but the second individual is not in need of the goods or services of the first individual.

To eliminate the inefficiencies of the barter economy, money-based economies were developed. In a money-based economy, a medium of exchange is employed wherein each individual business entity transfers his/her/its goods or services for an agreed upon price measured by a designated amount of the medium of exchange. At first, mediums of exchange were coins produced from precious metals (gold and silver) or copper. In addition, some cultures used shells, beads and the like in lieu of such coinage. Subsequently, paper money supplemented metallic coinage.

Somewhat concurrent with the development of money-based economies came the concept of money lending or “credit”. Here, an individual or business entity would advance goods/services or money to another premised upon the others promise to pay for the goods or services in the future or to repay the money lent. While not always the case, a fee was typically charged for the advancement of credit to the person who either borrowed the money or received the goods or services prior to payment.

The credit purchase system employing credit cards was introduced approximately fifty years ago, and this system is currently utilized for a substantial amount of consumer transactions on a worldwide basis. In the credit purchase system, a financial institution establishes an account for an account holder (such as an individual, business or other entity) and assigns an available credit limit to the account holder. This credit limit corresponds to the amount of money which the financial institution is willing to advance to the account holder.

The account holder may then charge financial transactions against the account up to the credit limit. The financial institution sends monthly statements to the account holder, and the account holder typically has the options of paying off all or a portion of the balance. The financial institution charges interest on any principal carried forward while the entity accepting the charge pays a fee to the financial institution for the convenience of receiving payment from the financial institution. A debit card transaction is processed similarly, except that the account holder draws against funds that already are on deposit in his/her/its account with the financial institution.

In either case, the account holder typically has a card imprinted with the cardholder's name, the account number and an expiration date. Also provided on the card is a security code, a place for the accountholders signature and a magnetic strip magnetically encoded with the account number. The facility accepting the card employs telecommunication lines to enter the card number, either by swiping the magnetic strip or by manual entry, and enters the purchase amount. If accepted, the financial institution generates an authorization code and the transaction is then completed.

Unfortunately, in the years since its introduction, the credit or debit card has become increasingly inexpensive and easy to counterfeit, forge or duplicate. The ubiquitous presence of credit and debit cards thus invites theft and improper use. Losses from misuse of credit and debit cards can be divided into at least two major categories: (1) Losses due to unauthorized use of the card or card information; and (2) Losses due to identity theft and subsequent misuse of identity information. Annual losses from both categories are estimated to exceed more than $20 billion and may be in excess of $50 billion at the time of this application.

Accordingly, there is a need to the transaction card system and methods that provide increased security over the current system. There is a need both to prevent unauthorized purchases due to a lost or stolen credit card as well as fraud and identity theft. There is a further need for a system and method that increases the difficulty of identity theft normally provided on such a transaction card. The present invention is directed to meeting these needs.

### SUMMARY OF THE DISCLOSURE

It is an object of the present invention to provide a new and useful transaction card system and method.

One aspect of the exemplary embodiment is the provision of a transaction card system and method that has increased security capabilities.

It is another aspect of the exemplary embodiment of the present invention to provide a high security transaction card system and method that can operate within the existing financial institution authorization framework.

Yet another aspect of the exemplary embodiment of the present invention is to provide a high security transaction card system and method that requires no changes in existing authentication, authorization, card usage or payment procedures between the account holder, the merchant and the financial institution.

Still a further aspect of the exemplary embodiment of the present invention is to provide a high security transaction card system and method that may be used without modifications or supplementation to existing point-of-sale facilities or procedures.

According to the exemplary embodiments of the present invention, a secure transaction card system is provided for a user. Broadly, this system includes a transaction card that has a first electrical contract structure, a power supply device, a card member storing a card identifier and a magnetic strip provided with a thin film magnetic write head with the thin film magnetic write head being in electrical communication with the power supply device.

This system also includes an authentication device with a housing that has an access slot adapted to receive an edge portion of the transaction card in the mated state. A second electrical contact structure is disposed in the housing and located such that the first and second electrical contact structures are placed in electrical communication with one another when in the mated state. The authentication device also includes an authentication processor in electrical communication with the second electrical contact structure and which has a programmable memory associated therewith which is operative to store account information corresponding to the transaction card and the card identifier. A power source is provided for providing electrical power to the system. When the transaction card is in the mated state, the authentication processor causes at least some of the account information to written onto the magnetic strip by the magnetic film write head as strip data.

In the exemplary embodiment, the transaction card includes a controller that has timing circuitry associated therewith. The controller is operative, after a selective period of time, to delete the strip data from the magnetic strip. In the disclosed embodiment, the deletion of the strip data is accomplished by overwriting the strip data with false data.

The power supply device associated with the transaction card may be a charge storage device that is charged by the power source of the authentication device when the transaction card and authentication card are in the mated state. This charge storage device may be a capacitor. Where the transaction card includes a controller, the controller can have timing circuitry associated therewith so that the controller is operative after a selected period of time to substantially drain the electric charge from the charge storage device.

The authentication device can include a data entry device, such as a keypad, whereby the user can input the account information, a personal identification number, code or the like. The authentication device can also include a display that is operative to display at least some of the account information stored in the programmable memory.

The housing of the authentication device may be provided with tamper resistant structure and circuitry whereby the account information stored in the programmable memory is deleted on violation of the integrity of the housing.

According to the disclosed exemplary method, a method of enabling a transaction card based transaction from an account is provided that includes the steps inherent in the above-described structure. Broadly, the described method includes providing an authentication device that includes a memory and a processor. The method also includes providing a transaction card that includes a writeable strip of magnetic media. The method includes the step of storing account information corresponding to the account in the programmable memory. The transaction card and the authentication device are mated such that selected account information may be transferred from the programmable memory and written onto the strip of magnetic media. The transaction card and authentication device are then de-mated whereby the transaction card may be used to affect a transaction from the account.

This general method may also employ a transaction card that contains a card identifier and wherein the memory includes a stored card identification number. The step of transferring the selected account information occurs only after verifying that the card identified as the mated transaction card corresponds to identification numbers stored in the memory. Optionally, the authentication device may include a data entry device. Here, also, the step of transferring the selected account information may occur only after entry of a personal code by a user.

These and other aspects of the exemplary embodiment of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a front plan view illustrating the high security transaction card system used to implement the method according to the exemplary embodiment of the present invention;

FIG. 2 is a front plan view of the transaction card component of the high security transaction card system of the present invention;

FIG. 3 is a rear plan view of the transaction card of FIG. 2;

FIG. 4 is a front plan view of the authentication device used with the high security transaction card system and method of the present invention;

FIG. 5 is a top end view in elevation of the authentication device shown in FIG. 4;

FIG. 6 is a diagrammatic view of the electronic components and circuitry used with the transaction card according to the present invention; and

FIG. 7 is a block diagram of the electronic components and circuitry of the authentication device of the present invention.

### DETAILED DESCRIPTION OF THE EXEMPLARY EMBODIMENTS

The present invention broadly concerns a high security transaction card system and method that may be used for various transactions. While this invention has particular application to transaction card based financial transfers (such as credit and debit card transactions), it should be understood that the system could be used in other applications wherein secure control of data or access may be desired. For example, the system and method could be implemented with library systems, student identification, medical care institutions, entryway and door controllers, etc.

The exemplary embodiment described below provides a system and method for increased security by separating the information necessary to complete a transaction into two components, neither of which individually can provide identification or account authorization. One component is an authentication device which is carried by the account holder and the authentication is required to authenticate and activate a complimentary transaction card component which may then be used to transfer necessary account information to a point-of-sale reader terminal once the transaction card component has been activated. The transaction card component, however, deactivates after a short interval of time so that it must be reactivated for a subsequent use.

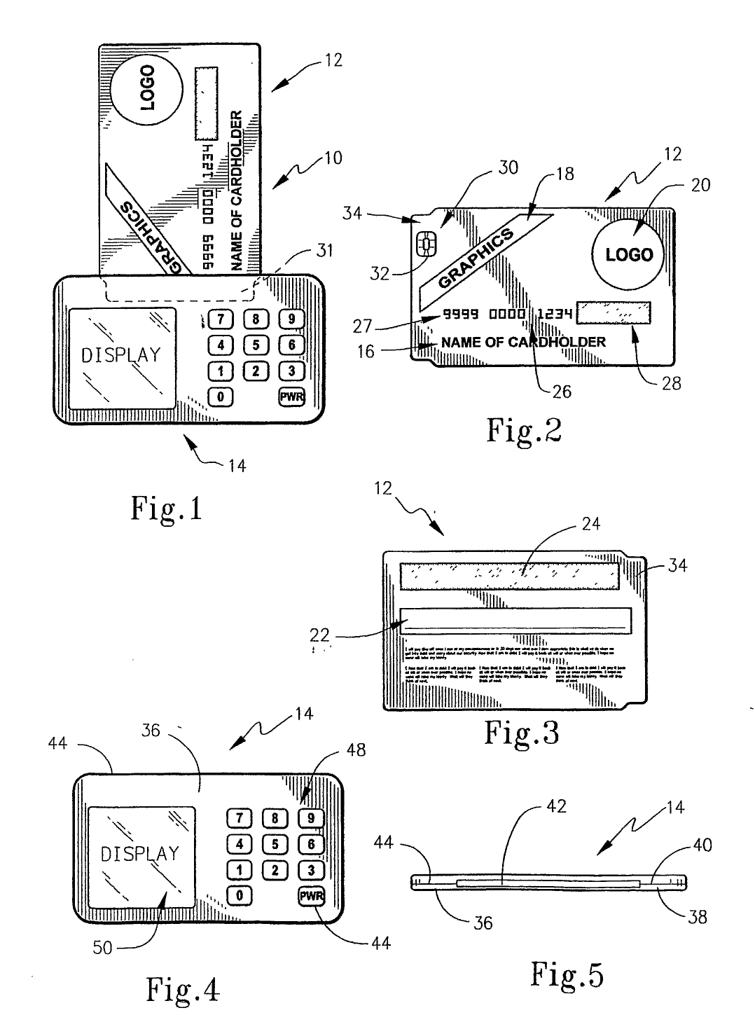

With reference, then, to FIG. 1, it may be seen that the transaction card system 10 according to the present invention includes two components, a transaction card 12 and an authentication device 14. In FIG. 1, card 12 is shown in a mated state with authentication device 14 so that the two components of the high security transaction card system may be implemented as described below.

With reference to FIGS. 1-3, it may be seen that transaction card 12 is similar in many regards to the typical transaction card in current use. Thus, for example, card 12 includes a region 16 for the name of the account holder and regions 18 and 20 for graphics and a logo or picture of the cardholder. The rear of the card has a region 22 for the cardholder's signature and a magnetic strip 24 which, when active, is encoded with the account information for the cardholder.

Card 12 departs from the standard transaction card, in two significant respects. While a portion of the account number 26 is imprinted on the card, the account number 27 is incomplete as indicated at 28. This prevents an unauthorized person from having the full account number readily available. In addition, card 12 has laminated therein card circuitry 30 that includes exposed electrical contacts 32. This circuitry includes a thin film magnetic write head that can place the desired account data on the magnetic strip. An edge portion 34 of card 12 is adapted for insertion into authentication device 14.

Card authentication device 14 is best illustrated in FIGS. 1, 4 and 5. Here, it may be seen that authentication device 14 includes an outer housing 36 that may be formed by two mating halves 38 and 40 that provide an open access slot 42 on one edge 44 thereof. The front of authentication device 14 includes an on/off button 46, a data entry device in the form of a numeric key pad 48, and a display 50 which may conveniently be a liquid crystal display. Authentication device 14 includes electronic circuitry that cooperates with card circuitry 30, as described below. To this end, slot 42 is sized and adapted to mateably engage edge portion 34 of card 12, as is illustrated in FIG. 1.

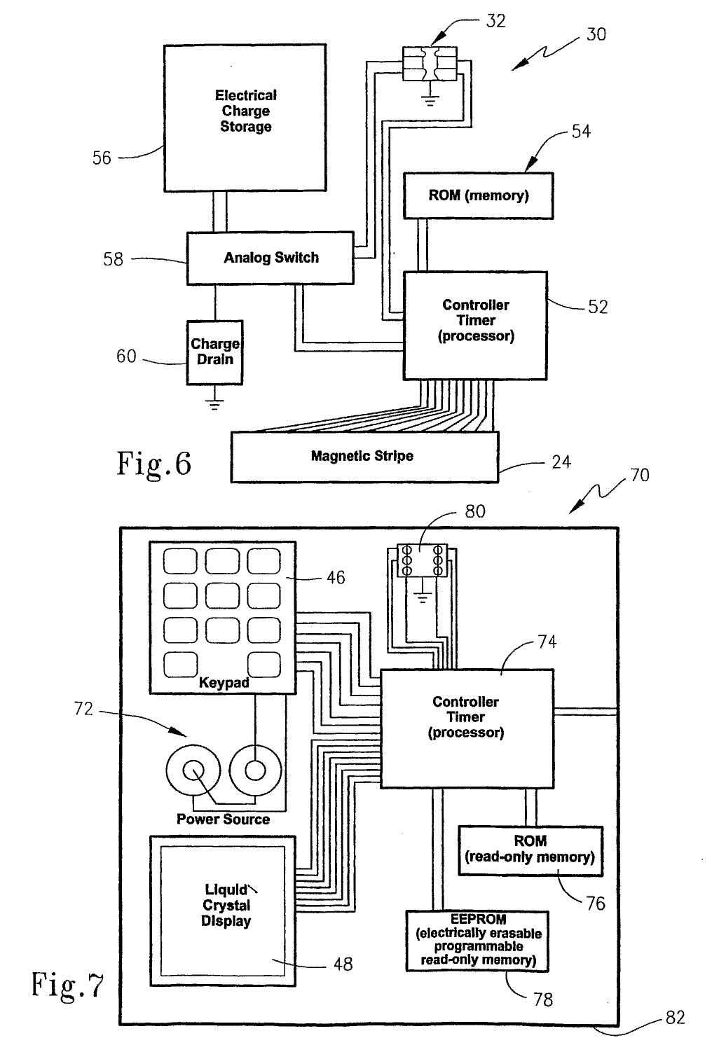

As noted, transaction card 12 and authentication device 14 contain complimentary electronics and programming. The electronics of card circuitry 30 is diagrammed in FIG. 6. Here, it may be appreciated that card circuitry 30 includes a controller 52 that includes timing circuitry. Card circuitry also includes a “read only” memory 54, and an electrical charge storage device 56 provides power to card circuitry 30 when charged, as described below. An analog switch 58 is interposed between charge storage device 56 and a charge drain 60 with analog switch 58 being controlled by a processor 52. Controller 52 also is in electrical communication with magnetic strip 24 so that it can selectively activate magnetic strip 24 to electromagnetically place the account number thereon. As noted, controller 52 includes timer circuitry associated therewith, the purpose of which is described below.

The electronic circuitry 70 of authentication device 14 is diagrammed in FIG. 7. Here, it may be seen that circuitry 70 includes a power source 72 that provides power to a processor 74 through keypad 46. The authentication device 14 will power up only when a suitable card is mated with it. However, the authentication device 14 can be turned off either by the power off button 73, by de-mating the card, or after the expiration of a timing interval.

The processor 74 has two memories associate therewith. These include “read only memory” (ROM) 76 and electrically erasable programmable read only memory (EEPROM) 78. Output from processor 74 is displayed on liquid crystal display 50. Electrical contacts 80 are provided to interface and make contact with electrical contacts 32 of transaction card 12 when in a mated state. Finally, an anti-tampering circuit, represented by box 82, is incorporated into the circuitry 70 to make housing 36 more tamper resistant. This anti-tampering circuit may be of any type typically known in the art or hereafter developed for similar devices to be protected against tampering.

With this in mind, the operation of the transaction card system and the methodology implemented thereby can be more fully appreciated. When an account holder, for example, opens an account, he/she receives both a transaction card 12 and an authentication device 14. The transaction card memory 54 has stored therein data corresponding to a card identifier that is unique to the card. Likewise, the authentication memory 76 has stored therein data corresponding to an authentication identifier that is unique to the authentication device. However, the authentication unit will not be operable.

In order to initiate the system, the account holder mates the card with the authentication device 14 and powers the unit on. The account holder next calls the issuing institution such as a credit administering agency. Once identifying himself/herself adequately as the account holder, he/she will receive an unlocking number, such as seven digits, that is entered by the keypad. If the unlock code corresponds to the authentication identifier, indicating that the person is the intended recipient of the system, the authentication device becomes unlocked or active, and the card identifier is read from the transaction card and stored also in memory 78.

The issuing agency then supplies the account holder with the appropriate account number (such as a sixteen digit account number) which the account holder enters into memory 78 by utilizing keypad 46. The user also enters a personal identification number (PIN) that is selected by the account holder. The PIN number is given to the issuing institution and will thereafter be used to authorize activation and use of card 12. Card 12 may be removed from authentication device 14, and authentication device 14 may be powered down.

When the account holder desires to use transaction card 12, card 12 is mated with authentication device 14 and the authentication device is turned on. Power is supplied to electrical charge storage device 56 from power source 72 through contacts 80 and contacts 32. Electrical charge storage device 56 may be a thin film capacitor, for example, and holds sufficient charge to enable controller 52 to magnetically encode magnetic strip 24 with account information. Magnetic strip 24, therefore, is provided with a thin film flexible magnetic “write” head. With transaction card 12 and authentication device 14 now powered up, the authentication unit reads the unique identifier on the card component and compares the identifier with the identifier stored in the memory 76.

Assuming that transaction card 12 is a card recognized by the specific authentication device 14, based on this identifier, the authentication device 14 will then request entry of the pin number from the account holder in order to proceed. Upon entry of the proper PIN number, the authentication unit device displays the complete account number on the display along with the security verification code and the expiration date for the card. This display will be presented for approximately one minute. The authentication device also transfers electrical charge to the capacitor in card 12 and provides the decrypted account number and all necessary information to activate the magnetic strip on the card. Controller 52 employs the thin film write head to place this information on magnetic strip 24 and initiates a timing circuit. The card 12 may now be removed from the authentication device 14, and it is used just as any ordinary credit or debit card at any point-of-sale terminal.

After the expiration of a selected time interval, such as three minutes, the timing sequence will complete and controller 52 will transmit logic zeros to the magnetic strip, thus erasing it and removing previously written account information. Controller 52 will then activate analog switch 58 so that the charge in charge storage device 56 will be drained. Card 12 is thus again inactive and must be reactivated by authentication device 14 utilizing the steps described above.

Should the account holder desire to utilize verbal transmission for a “card not present” transaction, such as occurs over a telephone or over the internet, the account holder mates card 12 with authentication device 14 and powers on authentication device 14. Upon entry of the proper PIN, as noted above, the display will present the complete account number, security/verification code and expiration date for a selected period. This period should be sufficient to permit verbal transmission of the information for the transaction. Once the card 12 is removed from the authentication device 14, authentication device 14 clears the display screen and sequence is shut down.

According to the above-description, it should be understood that the present invention also concerns a method of enabling transaction card-based transactions from an account or other transaction card-based activities. This method may include any of the steps inherent in the above-described structure.

Broadly, the exemplary method includes providing an authentication device that includes a memory and a processor. The method also includes providing a transaction card that includes a writeable strip of magnetic media. The method includes the step of storing account information corresponding to the account in the programmable memory. The transaction card and the authentication device are mated such that selected account information may be transferred from the programmable memory and written onto the strip of magnetic media. The transaction card and authentication device are then de-mated whereby the transaction card may be used to affect a transaction from the account.

This general method may also employ a transaction card that contains a card identifier and wherein the memory includes a stored card identification number. The step of transferring the selected account information occurs only after verifying that the card identified as the mated transaction card corresponds to identification numbers stored in the memory. Optionally, the authentication device may include a data entry device. Here, also, the step of transferring the selected account information may occur only after entry of a personal code by a user.

Accordingly, the present invention has been described with some degree of particularity directed to the exemplary embodiment of the present invention. It should be appreciated, though, that modifications or changes may be made to the exemplary embodiment of the present invention without departing from the inventive concepts contained herein.

We claim:

1. A secure transaction card system for a user, comprising:
(A) a transaction card including
(1) a first electrical contact structure,
(2) a power supply device,
(3) a card memory storing a card identifier; and
(4) a magnetic strip provided with a thin film magnetic write head and in electrical communication with said power supply device; and
(B) an authentication device including
(1) a housing having an access slot adapted to receive an edge portion of said transaction card in a mated state,
(2) a second electrical contact structure disposed in said housing and located such that said first and second electrical contact structures are placed in electrical communication with one another when in the mated state,
(3) a power source,
(4) an authentication processor in electrical communication with said second electric contact structure and said power source, and
(5) a programmable memory associated with said authentication processor and operative to store account information corresponding to said transaction card and the card identifier,
whereby, when said transaction card is in the mated state, said authentication processor causes at least some of the account information to be written onto said magnetic strip by said magnetic film write head as strip data.

2. A secure transaction card system according to claim 1 wherein said transaction card includes a controller having timing circuitry associated therewith, said controller operative after a selected period of time to delete the strip data from said magnetic strip.

3. A secure transaction card system according to claim 2 wherein said controller is operative to overwrite the strip data on said magnetic strip with false data.

4. A secure transaction card system according to claim 1 wherein said power supply device is a charge storage device that is charged by said power source when said transaction card and said authentication device are in the mated state.

5. A secure transaction card system according to claim 4 wherein said charge storage device is a capacitor.

6. A secure transaction card system according to claim 4 wherein said transaction card includes a controller having timing circuitry associated therewith, said controller operative after a selected period of time to substantially drain electric charge from said charge storage device.

7. A secure transaction card system according to claim 1 wherein said authentication device includes a data entry device whereby the user can input the account information.

8. A secure transaction card system according to claim 1 wherein said authentication device includes a display operative to display at least some of the account information stored by the programmable memory.

9. A secure transaction card system according to claim 1 wherein said housing is provided with tamper resistant structure and circuitry whereby the account information stored by said programmable memory is deleted upon violation of the housing.

10. A secure transaction card system, comprising
(A) a transaction card including
(1) a first electrical contact structure,
(2) a power supply device,
(3) a controller in electrical communication with said first electric contact structure,
(4) a card memory adapted to store a card identifier; and
(5) a magnetic strip provided with a thin film magnetic write head;
(B) an authentication device including
(1) a housing having an access slot adapted to receive an edge portion of said transaction card in a mated state
(2) a second electrical contact structure disposed in said housing and located such that said first and second electrical contact structures are placed in electrical communication with one another when in the mated state,
(3) a power source,
(4) an authentication processor in electrical communication with said second electric contact structure and said power source,
(5) an authentication memory operative to store an authentication identifier, and
(6) a programmable memory associated with said authentication processor and adapted to store the card identifier and account information corresponding to said transaction card, whereby, when said transaction card is in the mated state, said authentication processor validates said transaction card by comparing the card identifier in the card memory with the card identifier in the programmable memory and, upon successful validation, causes at least some of the account information to be written onto said magnetic strip by said magnetic film write head, said controller operative after a selected period of time to delete the account information from said magnetic strip.

11. A secure transaction card system according to claim 10 wherein said controller is operative to overwrite the strip data on said magnetic strip with false data.

12. A secure transaction card system according to claim 10 wherein said power supply device is a charge storage device that is charged by said power source when said transaction card and said authentication device are in the mated state.

13. A secure transaction card system according to claim 10 wherein said authentication device includes a data entry device whereby the user can input the account information and a personal identification number for storage in the programmable memory.

14. A secure transaction card system according to claim 10 wherein said authentication device includes a display operative to display at least some of the account information stored by the programmable memory.

15. A secure transaction card system according to claim 10 wherein said housing is provided with tamper resistant structure and circuitry whereby the account information stored by said programmable memory is deleted upon violation of the housing.

16. A method of enabling a transaction card based transaction from an account, comprising:
(A) providing an authentication device that includes a memory and a processor;
(B) providing a transaction card that includes a writeable strip of magnetic media;
(C) storing account information corresponding to the account in the programmable memory;
(D) mating said transaction card and said authentication device;
(E) transferring selected account information from said programmable memory such that it is written on the strip of magnetic media; and
(F) demating said transaction card and said authentication device whereby said transaction card may be used to effect a transaction from the account.

17. The method according to claim 16 wherein said transaction card contains a card identifier and said memory includes a stored card identification number, the step of transferring the selected account information occurring only after verifying that the card identifier of the mated transaction card corresponds to the identification number stored in the memory.

18. The method according to claim 16 wherein said authentication device includes a data entry device, the step of transferring the selected account information occurring only after entry of a personal code by a user.
